(19) United States
(12) Patent Application Publication
(10) Pub. No.: US 2008/0198322 A1
(43) Pub. Date: Aug. 21, 2008

(54) Device for Training Muscles for Controlling Eyes

(76) Inventors: Kwei-Haw HWONG, Taichung City (TW); Hsien-Chang Lin, Taichung City (TW)

Correspondence Address: Dr. BANGER SHIA, 102 Lindencrest Ct., Sugar Land, TX, 77479-5201, US

(21) Appl. No.: 11/676,493

(22) Filed: Feb. 19, 2007

(51) Int. Cl. A61H 5/00

(52) U.S. Cl. 351/41

(57) ABSTRACT

An eye-training machine includes a front frame, a rear frame, two prisms and a driving unit. The front frame defines two windows. The rear frame defines two windows corresponding to the windows of the front frame. The prisms are disposed between the front and rear frames corresponding to the windows. The driving unit rotates the prisms.

### BACKGROUND OF INVENTION

1. Field of Invention

2. Related Prior Art

About 75% of the population in Taiwan suffer from myopia, the worst all over the world. Most of these people suffer from myopia for two causes. The first cause is insufficient exercise of the eyes. As only a small fraction of the visual functions is used, the other fraction of the visual functions will deteriorate due to inadequate exercise of the muscles for controlling the eyes.

The second reason is abuse of the eyes. For example, the pressure of survival would cause psychological stress that would in turn cause insufficient circulation of blood for the eyes. For example, the eyes are focused on a same spot for a long period of time while playing video games, watching television or working with computers.

The ciliary body controls the thickness of the lens so that the lens focuses correctly. The medial rectus pulls the eyeball so that the eyeball looks toward the nose. The lateral rectus pulls the eyeball so that the eyeball looks toward the side. The superior rectus makes the eyeball look upward. The inferior rectus makes the eyeball look downward and inward. The superior oblique swivels the eye so that the eye looks downward and outward. The inferior oblique makes the eye look upward and outward.

To make people use the muscles for controlling the eyes by making them look at distant objects, adjacent objects and rotating objects, there have been various training devices. Examples of such training devices can be found in Taiwanese Patent Publication Nos. 535577, 561041 and 567845. The training device disclosed in Taiwanese Publication No. 535577 is bulky in size. The training device disclosed in Taiwanese Publication No. 561041 is complicated in structure. The training device disclosed in Taiwanese Publication No. 567845 is inconvenient in use.

There are even devices for messaging the muscles for controlling the eyes. Such messaging devices might cause injury to the eyes.

The present invention is therefore intended to obviate or at least alleviate the problems encountered in prior art.

### SUMMARY OF INVENTION

The primary objective of the present invention to provide a structurally simple, portable eye-training device.

According to the present invention, an eye-training device includes a front frame, a rear frame, two prisms and a driving unit. The front frame defines two windows. The rear frame defines two windows corresponding to the windows of the front frame. The prisms are disposed between the front and rear frames corresponding to the windows. The driving unit rotates the prisms.

Other objectives, advantages and features of the present invention will become apparent from the following description referring to the attached drawings.

### BRIEF DESCRIPTION OF DRAWINGS

The present invention will be described via detailed illustration of three embodiments referring to the drawings wherein:

FIG. 1 is a perspective view of an training device according to the first embodiment of the present invention;

FIG. 2 is an exploded view of the training device shown in FIG. 1;

FIG. 3 is a cross-sectional view of the training device shown in FIG. 1;

FIG. 4 is another cross-sectional view of the training device shown in FIG. 1;

FIG. 5 is a cross-sectional view of the training device in an active state other than an idle state shown in FIG. 3;

FIG. 6 is a simplified side view of an eye;

FIG. 7 is a simplified side view of a prism located in front of the eye;

FIG. 8 is a simplified side view of the prism and the eye in another position than shown in FIG. 7;

FIG. 9 is a perspective view of a training device according to the second embodiment of the present invention;

FIG. 10 is a simplified side view of a lady using the training device shown in FIG. 9; and

FIG. 11 is a simplified side view of a lady using a training device according to the third embodiment of the present invention.

### DETAILED DESCRIPTION OF EMBODIMENTS

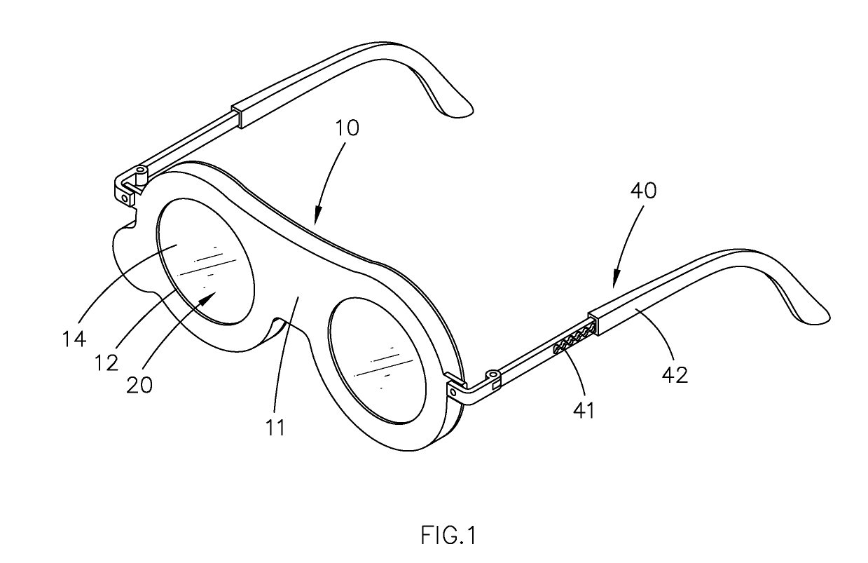

Referring to FIG. 1, there is shown a training device 10 in the form of glasses according to a first embodiment of the present invention.

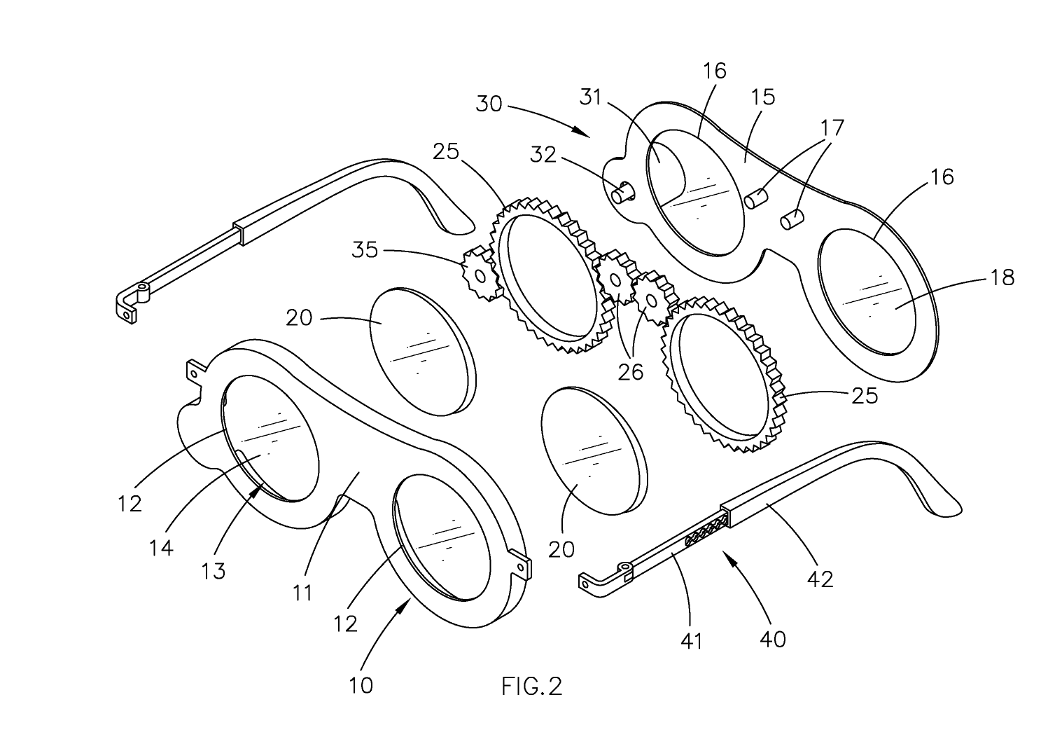

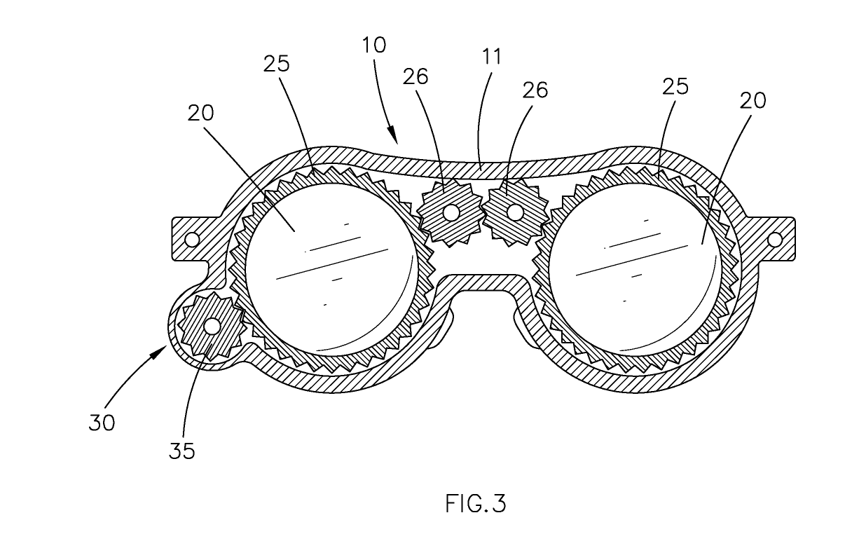

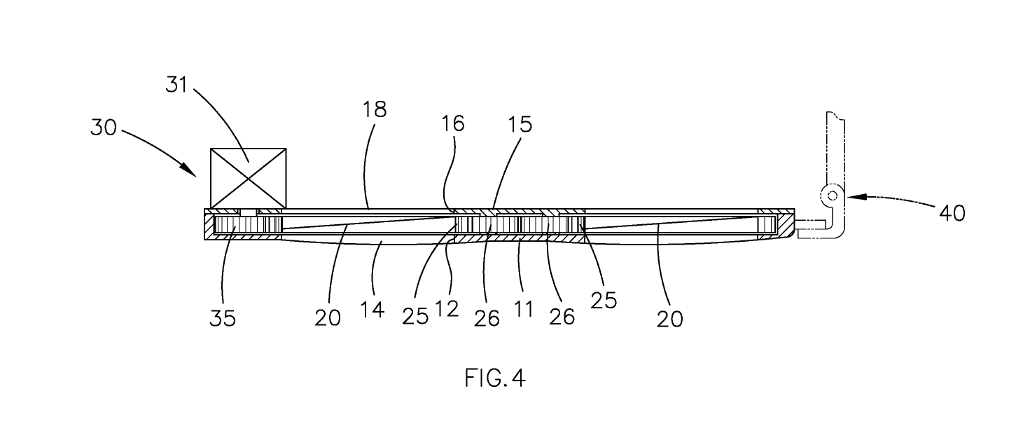

Referring to FIG. 2 through 4, the training device 10 includes a front frame 11, two prisms 20, a rear frame 15, a driving unit 30 and two temples 40.

The front frame 11 defines two windows 12 and two cavities 13 in communication with the windows 12. A lens 14 is fit in each of the windows 12.

Each of the prisms 20 is rotationally disposed in a related one of the cavities 13.

The rear frame 15 defines two windows 16. A lens 18 is fit in each of the windows 16. Two shafts 17 are formed on the rear frame 15.

The driving unit 30 includes a motor 31, a driving pinion 35, two annular gears 25 and two transmission pinions 26. The motor 31 is attached to the rear frame 15.

The motor 31 includes a mandrel 32 inserted through the rear frame 15. The driving pinion 35 is secured to the mandrel 32. The first annular gear 25 is engaged with the driving pinion 35. The first transmission pinion 26 is engaged with the first annular gear 25. The second transmission pinion 26 is engaged with the first transmission pinion 26. The second annular gear 25 is engaged with the second transmission pinion 26.

Each of the annular gears 25 is securely disposed around a related one of the shafts 17. Each of the transmission pinions 26 is rotationally disposed on a related one of the shafts 17.

The frames 11 and 15 are joined together so that the prisms 20, the annular gears 25 and the transmission pinions 26 and driving pinion 35 are kept between the frames 11 and 15.

Each of the temples 40 includes a first portion 41 and a second portion 42 telescopically connected to the first portion 41. Thus, the temples 40 can be extended and contracted.

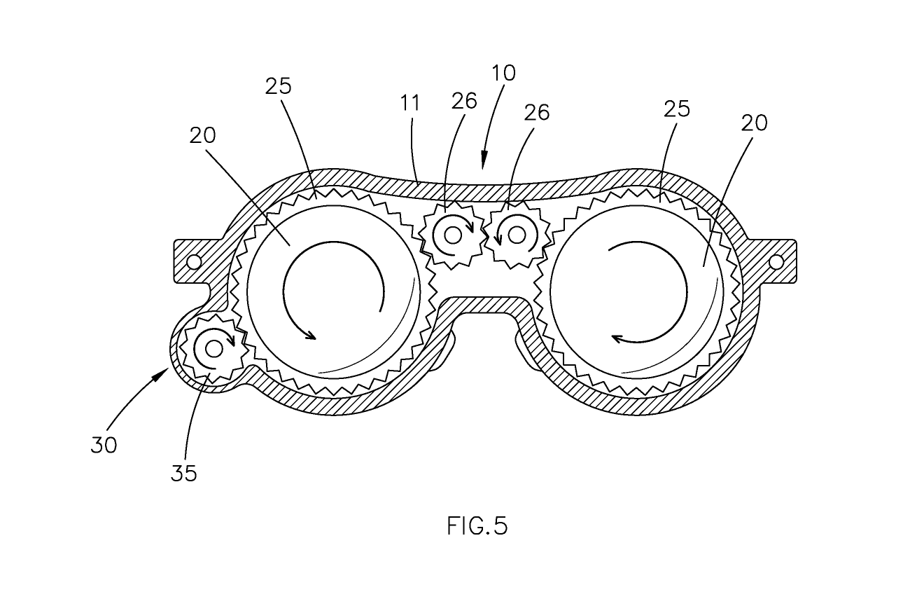

Referring to FIG. 5, the driving pinion 35 rotates clockwise. The first annular gear 25 and the first prism 20 rotate counterclockwise. The first transmission pinion 26 rotates clockwise. The second transmission pinion 26 rotates counterclockwise. The second annular gear 25 and the second prism 20 rotate clockwise.

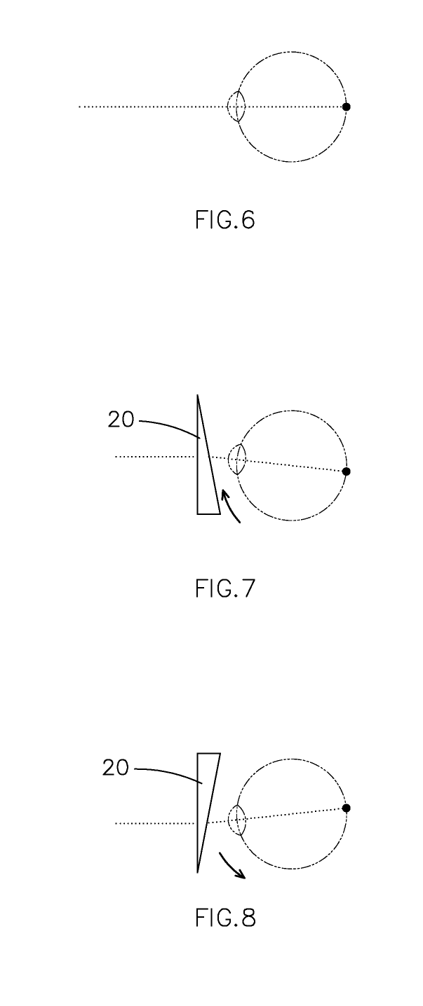

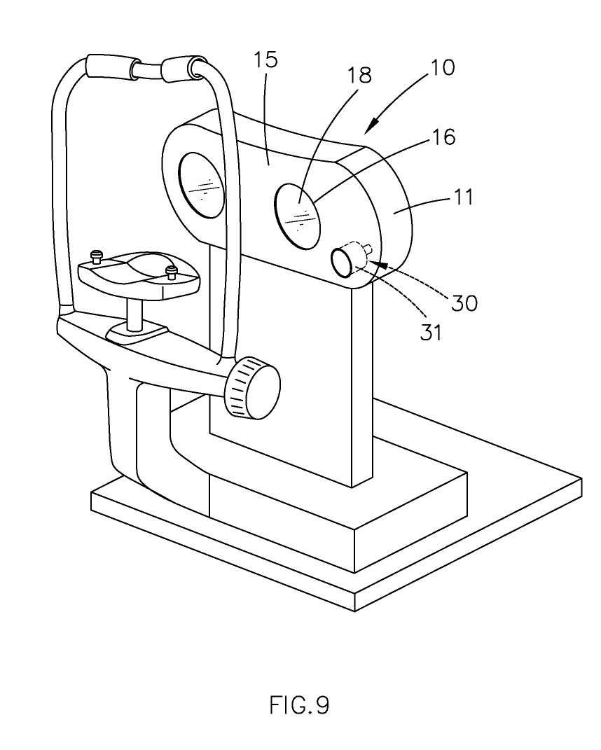

While rotating as shown in FIG. 5, a prism 20 causes an eye to rotate as shown in FIGS. 6 through 8. That is, the rotating prism 20 causes the muscles for controlling the eye to exercise. Therefore, the capability of convergence, divergence and rotation of the muscles for controlling the eye is improved.

Moreover, the rotating prism 20 refracts light into the macula lutea from various angles, increases the area of the macula lutea for receiving the light, and enhances the photo-dissociation of the retina and the optic nerves. Thus, the aging of the macula lutea is reduced. The sensitivity of the sight is increased.

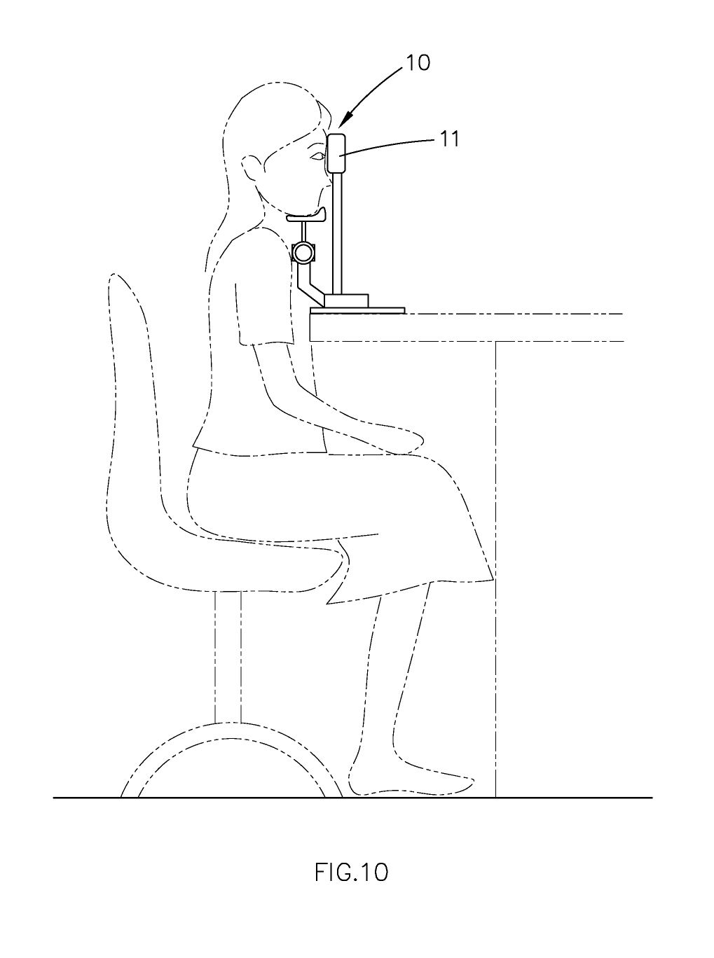

Referring to FIGS. 9 and 10, there is shown a training device 10 in the form of an optometer according to a second embodiment of the present invention.

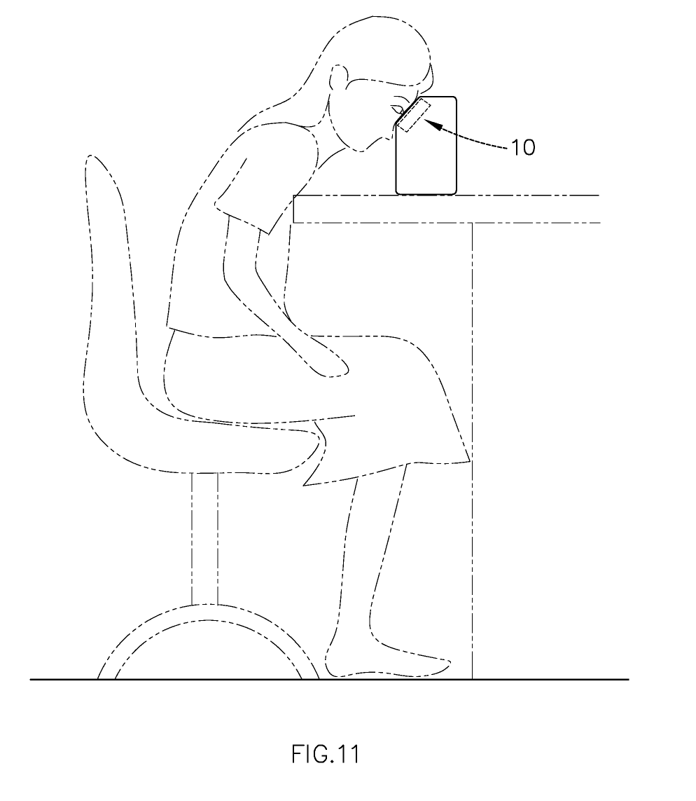

Referring to FIG. 11, there is shown a training device 10 in the form of a machine for inspecting colorblindness according to a third embodiment of the present invention.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An eye-training device comprising:
a front frame defining two windows;
a rear frame defining two windows corresponding to the windows of the front frame;
two prisms disposed between the front and rear frames corresponding to the windows; and
a driving unit for rotating the prisms.

2. The eye-training device according to claim 1 wherein the driving unit comprises a motor and a gear train through which the motor drives the prisms.

3. The eye-training device according to claim 2 wherein the gear train comprises:
a driving pinion secured to a mandrel of the motor;
a first annular gear engaged with the driving pinion and disposed around one of the prisms;
a first transmission pinion engaged with the first annular gear;
a second transmission pinion engaged with the first transmission pinion;
a second annular gear engaged with the second transmission pinion and disposed around the other prism.

4. The eye-training device according to claim 3 wherein the rear frame comprises two shafts for supporting the first and second transmission pinions.

5. The eye-training device according to claim 1 comprising two lenses fit in the windows of the front frame.

6. The eye-training device according to claim 1 comprising two lenses fit in the windows of the rear frame.

7. The eye-training device according to claim 1 comprising tow temples connected to one of the front and rear frames.
